(19) United States
(12) Patent Application Publication
(10) Pub. No.: US 2011/0051410 A1
(43) Pub. Date: Mar. 3, 2011

(54) IN-WALL LED LAMP CAN BE ADJUSTABLE IN ANGLES

(76) Inventor: Chien Kuo Liang, Chung-Ho City (TW)

(21) Appl. No.: 12/549,424

(22) Filed: Aug. 28, 2009

(51) Int. Cl. F21V 1/00; F21V 17/00; F21V 21/00

(52) U.S. Cl. 362/235; 362/366; 362/227

(57) ABSTRACT

An in-wall LED lamp can be adjustable in angles is provided. More particularly, the LED lamp includes a light-emitting assembly that is mounted in a frame and adjustable to various projection angles. The LED lamp is characterized in that a lamp body is provided with heat-dissipation fins, a transformer, and a light-emitting unit, and the lamp body is coupled to an in-wall frame by screws, so as for the LED lamp to have a simplified structure and be adjustable to various projection angles.

### BACKGROUND OF THE INVENTION

1. Technical Field

The present invention relates to an in-wall LED (light-emitting diode) lamp can be adjustable in angles. More particularly, the present invention relates to an LED lamp whose light-emitting assembly is mounted in a frame and adjustable to various projection angles. Even more particularly, the present invention relates to an LED lamp including a lamp body coupled to an in-wall frame by screws such that the LED lamp is structurally simplified and can be adjusted to various projection angles.

2. Description of Related Art

It is well known that conventional in-wall lamps include in-wall incandescent lamps and in-wall LED lamps. A conventional in-wall lamp essentially includes an in-wall frame, a lamp body, and a light-emitting unit or light bulb. While the projection angle of the light-emitting unit or light bulb is adjustable, the adjustment of projection angle can only be achieved by adjusting the light-emitting unit or light bulb itself due to structural constraints. Moreover, the conventional in-wall lamps are disadvantaged by structural complexity, difficult maintenance, and high production costs.

Besides, since the light-emitting unit of an LED lamp in general is not a light bulb with a metal filament that works by incandescence, but an LED chip that works on the principle of semiconductor diodes and may easily burn under high temperature, an LED lamp must be equipped with an efficient heat dissipation mechanism, which nevertheless leads to the complicated structure of conventional in-wall LED lamps. In addition, as previously mentioned, the projection angle of a conventional in-wall LED lamp can only be adjusted by adjusting the light-emitting unit itself.

### BRIEF SUMMARY OF THE INVENTION

In view of the aforesaid shortcomings of the conventional in-wall lamps, the inventor of the present invention conducted extensive research and finally succeeded in developing an in-wall LED lamp can be adjustable in angles as disclosed herein. The disclosed in-wall LED lamp is characterized by integrating heat dissipation fins, a transformer, and a light-emitting unit into a lamp body. The lamp body is further coupled to an in-wall frame by screws such that the LED lamp is structurally simplified and adjustable to various projection angles.

### BRIEF DESCRIPTION OF THE SEVERAL VIEWS OF THE DRAWINGS

FIG. 1 is a perspective view of an in-wall LED lamp can be adjustable in angles according to the present invention;

FIG. 2 is a side view of the LED lamp according to the present invention;

FIG. 3 is an exploded perspective view of the LED lamp according to the present invention;

FIG. 4 is a perspective view showing angular adjustment of the LED lamp according to the present invention;

FIG. 5 is a side view of FIG. 4;

FIG. 6 is another perspective view showing angular adjustment of the LED lamp according to the present invention; and

FIG. 7 is a side view of FIG. 6.

### DETAILED DESCRIPTION OF THE INVENTION

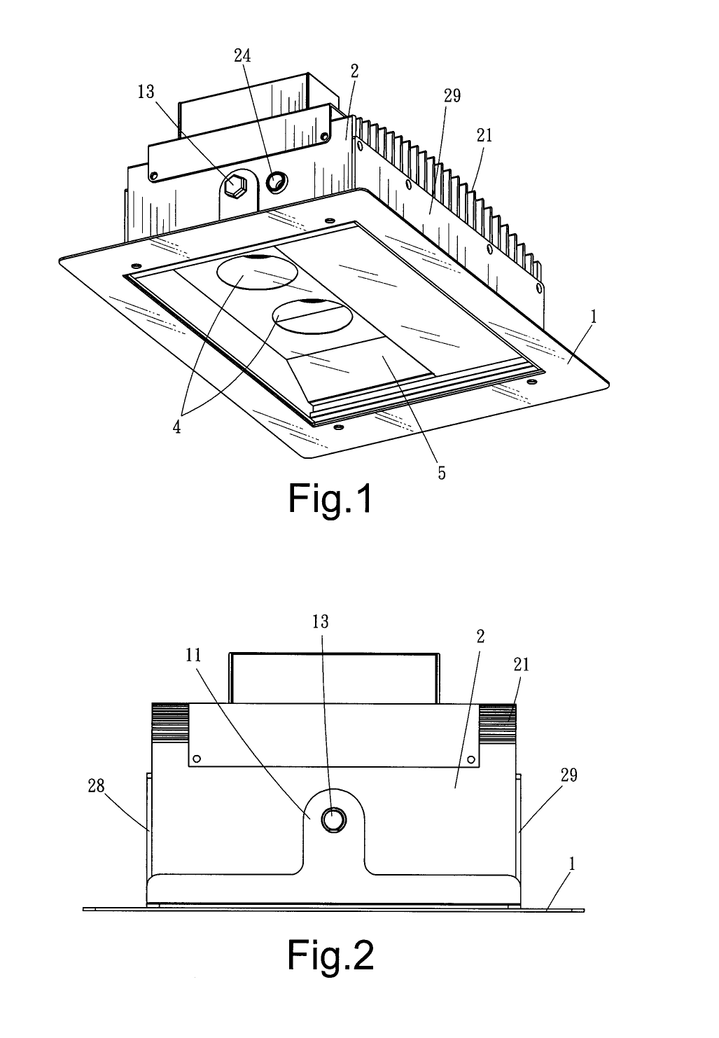

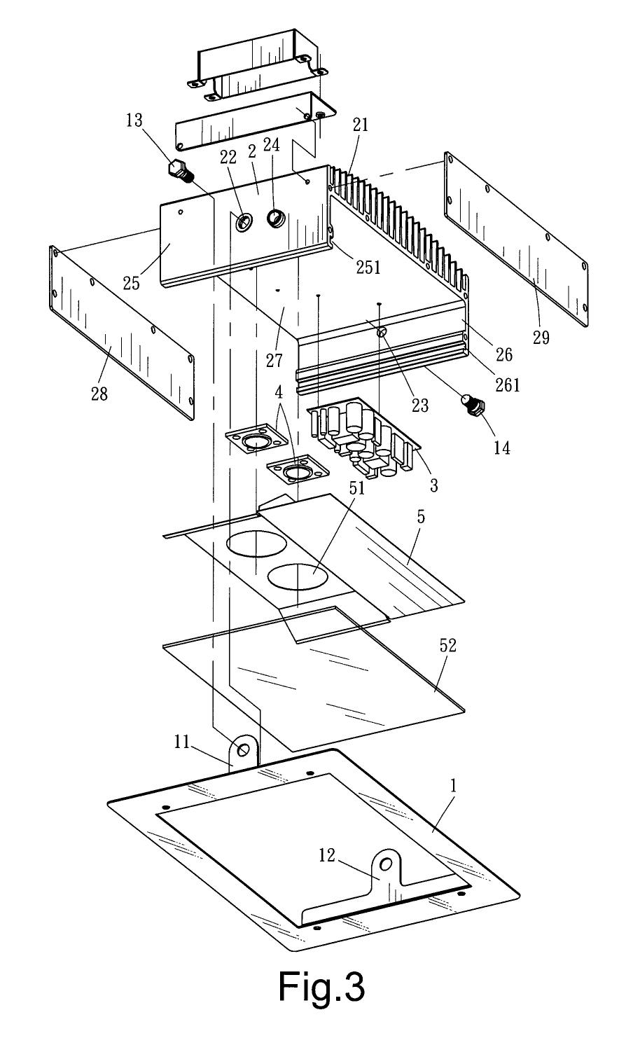

Referring to FIG. 1 and FIG. 3, an in-wall LED lamp can be adjustable in angles according to the present invention essentially includes an in-wall frame 1, an aluminum extruded fin body 2, a transforming element 3, a light-emitting element 4, and a light-guiding plate 5.

The aluminum extruded fin body 2 has an upper portion formed with parallel heat dissipation fins 21. The aluminum extruded fin body 2 also has two lateral sides provided with threaded holes 22, 23, respectively, wherein one of the lateral sides is further formed with a through hole 24. In addition, the aluminum extruded fin body 2 is provided with extension plates 25, 26 such that a cavity 27 is formed at a central portion of the aluminum extruded fin body 2. The transforming element 3 and one or more light-emitting elements 4 are fixedly provided in the cavity 27. The light-emitting elements 4 are electrically connected to a direct-current (DC) power output end of the transforming element 3. An alternating-current (AC) power input end of the transforming element 3 is electrically connected to an AC power line that passes through the through hole 24 of the aluminum extruded fin body 2, and said transforming element 3 there are one or more said transforming elements.

The extension plates 25, 26 provided bilaterally on the aluminum extruded fin body 2 have lower ends whose inner surfaces are formed with grooves 251, 261, respectively. The grooves 251, 261 are configured for receiving the light-guiding plate 5. The light-guiding plate 5 is formed with through holes 51 corresponding in number and position to the light-emitting elements 4. Thus, when received by the grooves 251, 261, the light-guiding plate 5 covers the transforming element 3 but allows light emitted by the light-emitting elements 4 to pass through. In addition, a light-penetrable isolation plate 52 is provided outward of the light-guiding plate 5.

Besides, end plates 28, 29 are fixedly provided at two ends of the cavity 27 of the aluminum extruded fin body 2.

The in-wall frame 1 is bilaterally provided with extension plates 11, 12 to be passed through by screws 13, 14, respectively, so as for the screws 13, 14 to pass through the holes 22, 23 at the two lateral sides of the aluminum extruded fin body 2 and be coupled with nuts from inside the aluminum extruded fin body 2, respectively.

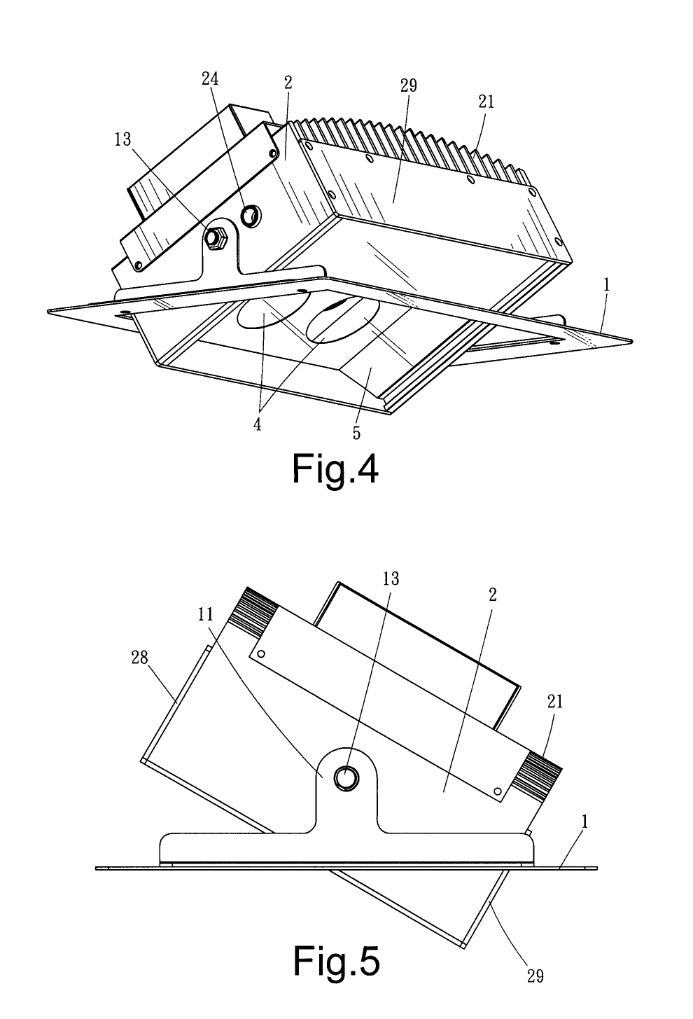

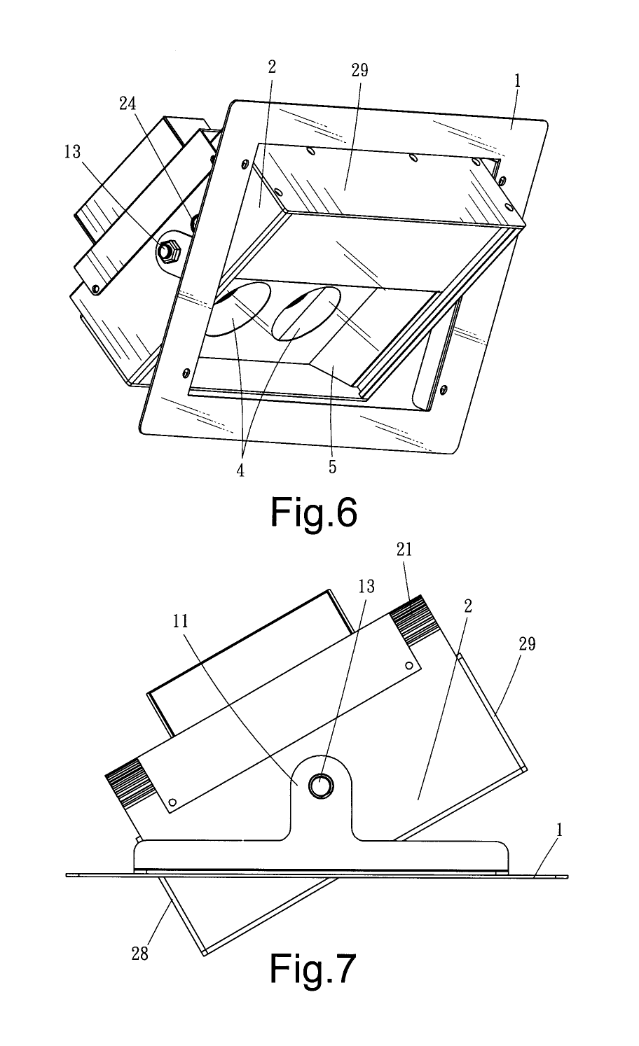

Thus, the LED lamp which includes the aluminum extruded fin body 2, the transforming element 3, the light-emitting elements 4, and the light-guiding plate 5 can be adjusted to various projection angles, as shown in FIG. 4 through FIG. 7.

What is claimed is:

1. An in-wall LED (light-emitting diode) lamp can be adjustable in angles, essentially comprising an in-wall frame, an aluminum extruded fin body, a transforming element, a light-emitting element, and a light-guiding plate, the aluminum extruded fin body being provided therein with the transforming element, the light-emitting element, and the light-guiding plate, the in-wall frame being bilaterally provided with extension plates to be passed through by screws, respectively, so as for the screws to pass through holes at two lateral sides of the aluminum extruded fin body and be coupled with nuts from inside the aluminum extruded fin body, respectively, thus allowing the LED lamp comprising the aluminum extruded fin body, the transforming element, the light-emitting element, and the light-guiding plate to be adjusted to various projection angles.

2. The in-wall LED lamp can be adjustable in angles of claim 1, wherein there are one or more said transforming elements.

3. The in-wall LED lamp can be adjustable in angles of claim 1, wherein there are one or more said light-emitting elements.

4. The in-wall LED lamp can be adjustable in angles of claim 1, wherein the light-guiding plate is formed with at least a through hole corresponding in number and position to the light-emitting element such that the light-guiding plate, when put in place, covers the transforming element but allows light emitted by the light-emitting element to pass through, wherein a light-penetrable isolation plate is further provided outward of the light-guiding plate.

5. The in-wall LED lamp can be adjustable in angles of claim 1, wherein the light-emitting element is electrically connected to a direct-current (DC) power output end of the transforming element, and an alternating-current (AC) power input end of the transforming element is electrically connected to an AC power line.
